(19) United States
(12) Patent Application Publication
(10) Pub. No.: US 2008/0225350 A1
(43) Pub. Date: Sep. 18, 2008

(54) Contact-image-sensor scanner configurable for scanning opaque and transparent media

(76) Inventor: David Troy Roberts, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/717,249

(22) Filed: Mar. 13, 2007

(51) Int. Cl. H04N 1/031

(52) U.S. Cl. 358/482

(57) ABSTRACT

A scanner has a movable carriage, a contact image sensor located on the carriage, and a platen that is substantially transparent to visible light overlying the carriage and the contact image sensor. The scanner is selectively configurable between a first scanning mode for scanning substantially opaque media positioned on the platen and a second scanning mode for scanning media substantially transparent to visible light underlying the platen. At least one image on the substantially opaque media is located within a depth of field of the contact image sensor when the substantially opaque media is positioned on the platen. At least one image on the media substantially transparent to visible light is located within the depth of field of the contact image sensor when the media substantially transparent to visible light underlies the platen.

### BACKGROUND

Contact image sensors (CISs) are replacing charge-coupled devices (CCDs) in image-capturing devices, such as scanners, all-in-one devices, e.g., where more compact and/or less expensive scanners are desirable, etc. Contact image sensors are typically positioned close to a glass platen of a scanner so that when a medium containing one or more images to be scanned is placed on the platen, the medium is substantially closer to the contact image sensor than that medium would be to a charge-coupled device. This is because contact image sensors typically have a smaller depth of field (or region of useful image quality) than do charge-coupled devices so that media to be scanned typically need to be closer to a contact image sensor than a charge-coupled device to be in focus.

However, the smaller depth of field can cause problems when scanning at least partially transparent media, such as transparencies, photo-negatives, slides, etc. This is because transparent media are often held off the platen by a small distance, e.g., by a border surrounding the media, as in the case of slides, or by a template that contains the transparent media, so that the transparent media does not become scratched by debris that might be on the platen. Holding the transparent media off the platen by a small distance, however, can move the transparent media outside of the depth of field of the contact image sensor so that the image on the transparent media is out of focus, causing the scan of the image to be blurred.

### DESCRIPTION OF THE DRAWINGS

FIG. 1 is a perspective view illustrating an embodiment of a scanner operating in an opaque scanning mode for scanning substantially opaque media, according to an embodiment of the disclosure.

FIG. 2 is a cross-sectional side view of an embodiment of a scanner operating in an opaque scanning mode, according to another embodiment of the disclosure.

FIG. 3 is a perspective view illustrating an embodiment of a scanner operating in a transparent scanning mode for scanning media substantially transparent to visible light, according to another embodiment of the disclosure.

FIG. 4 is a cross-sectional side view of an embodiment of a scanner operating in a transparent scanning mode, according to another embodiment of the disclosure.

FIGS. 5A and 5B are side views illustrating raising and lowering an upper portion of an embodiment of a scanner, according to another embodiment of the disclosure.

FIGS. 6A and 6B are side views illustrating an embodiment for manually raising and lowering an upper portion of an embodiment of a scanner, according to another embodiment of the disclosure.

FIGS. 7A and 7B are side views of an embodiment of a carriage of an embodiment of a scanner in two different operating modes, according to another embodiment of the disclosure.

FIG. 7C is a view taken along line 7C-7C of FIG. 7B, according to another embodiment of the disclosure.

FIG. 8 illustrates a depth of field of an embodiment of a contact image sensor, according to another embodiment of the disclosure.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

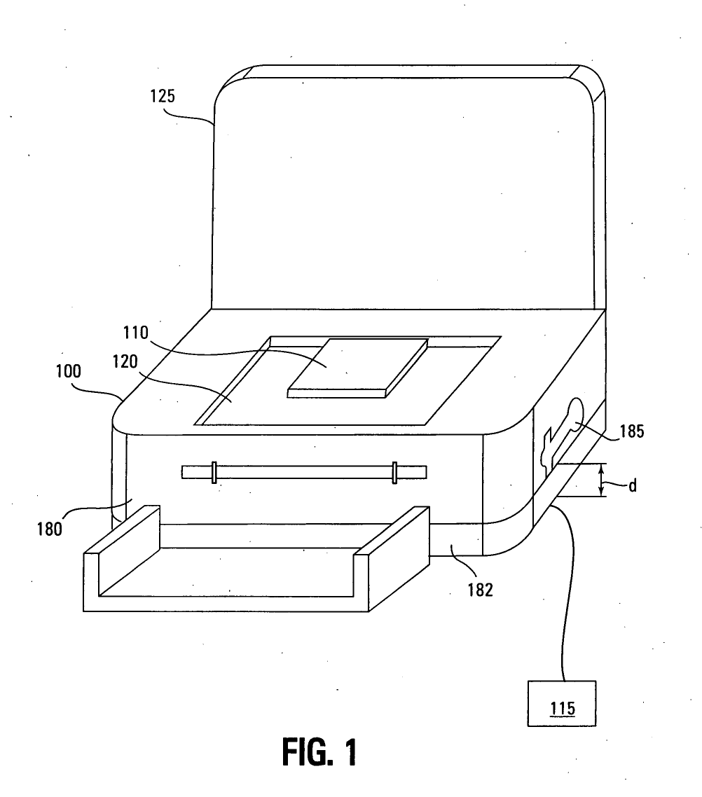

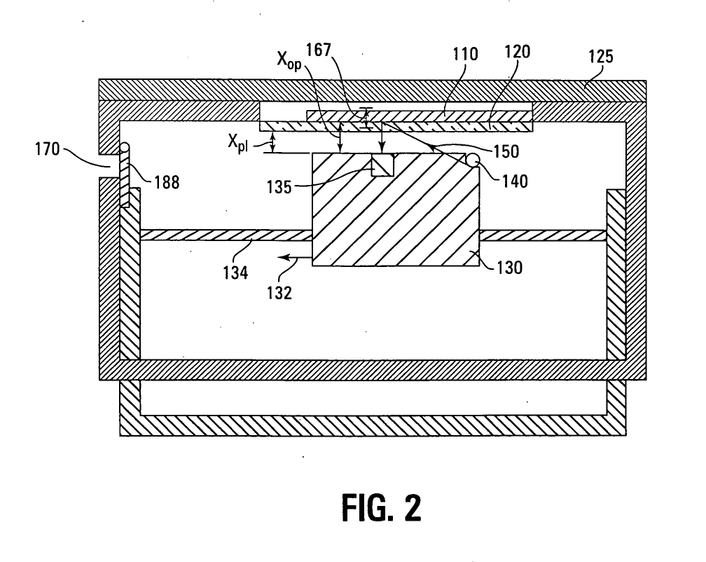

FIGS. 1 and 2 illustrate a contact-image-sensor- (or CIS-) type scanner 100 operating in an opaque scanning mode for scanning substantially opaque media 110, such as paper, according to an embodiment, where FIG. 1 is a perspective view and FIG. 2 is a cross-sectional side view. For one embodiment, scanner 100 is an integral component of an all-in-one device that can function as a facsimile machine, a printer, and a copier in addition to a scanner. For another embodiment, scanner 100 may be electronically coupled to an external computer 115.

During scanning in the opaque scanning mode, opaque media 110 is positioned on a platen 120, e.g., of clear glass or plastic, that is substantially transparent to visible light. A cover 125 of scanner 100 may be closed to overlie opaque media 110 during scanning, as shown in FIG. 2. Scanner 100 has a movable carriage 130 that underlies platen 120 and thus opaque media 110. Carriage 130 moves in the direction of arrow 132, relative to opaque medium 110, while scanning opaque medium 110. When scanning is completed, carriage 130 is moved in a direction opposite arrow 132 to an initial position from where another scan may be initiated. For one embodiment, carriage 130 may ride on a rail 134, as shown in FIG. 2, or within slots that provide a track (not shown).

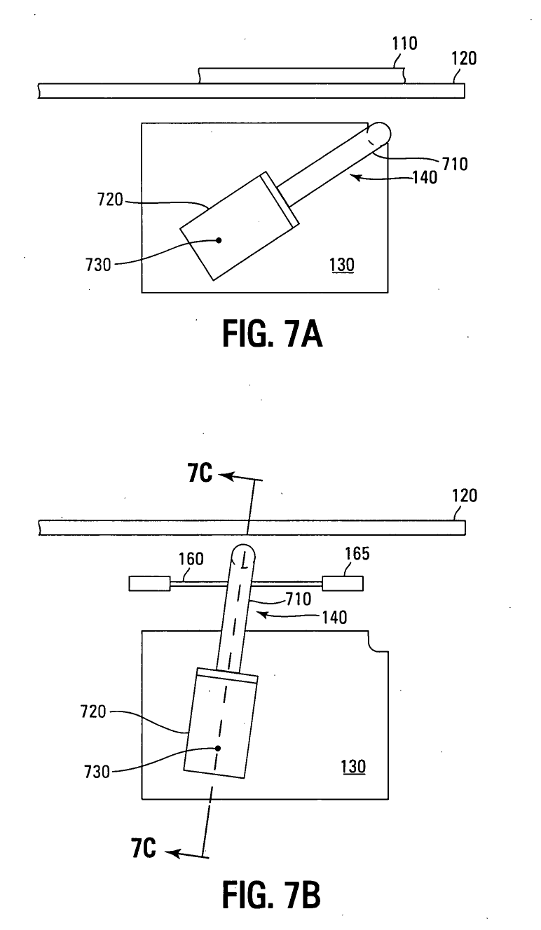

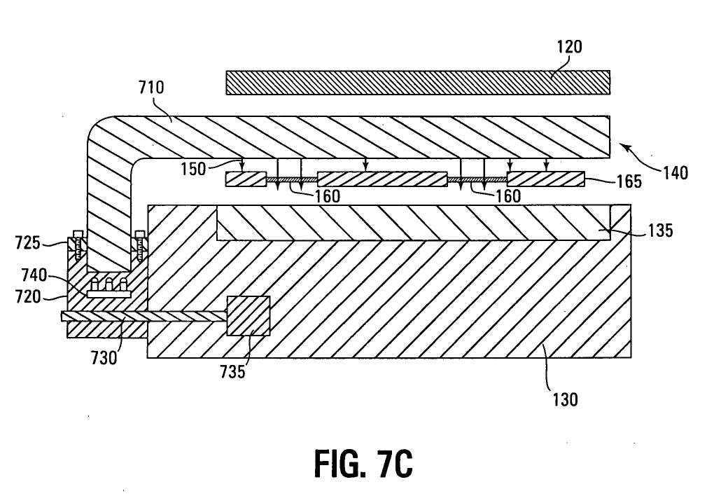

A radiation source, such as a light source 140, is connected to carriage 130 for movement therewith. As discussed below in conjunction with FIG. 7C, for one embodiment, light source 140 may include a light-pipe that is movably connected carriage 130 for movement relative to carriage 130. For another embodiment, light source 140 may further include one or more light emitting diodes (LEDs) optically coupled to the light-pipe. Note that in the opaque scanning mode, opaque medium 110 overlies light source 140 so that platen 120 is interposed between opaque medium 110 and light source 140.

A contact-image-sensor (or CIS) chip 135 is disposed on carriage 130 for converting light received thereat into one or more electronic signals. For one embodiment, CIS chip 135 may include an array of photosensing elements or photodevices, such as phototransistors or photodiodes, e.g., formed on a semiconductor substrate, such as silicon, using semiconductor processing techniques. Each photodevice forms a pixel and detects light signals and accumulates electrical charges corresponding to the intensity of the detected light signals.

When scanning opaque media 110 in the opaque scanning mode, light 150, e.g., visible light, from light source 140 is directed through platen 120 and onto a downward facing surface of opaque medium 110, as shown in FIG. 2. The downward facing surface of opaque medium 110 reflects light 150 onto CIS chip 135. CIS chip 135 converts the reflected light into one or more electronic signals that correspond to one or more images on opaque medium 110. For one embodiment, the electronic signals may sent to computer 115 (FIG. 1) for processing, or may be processed by firmware of scanner 100.

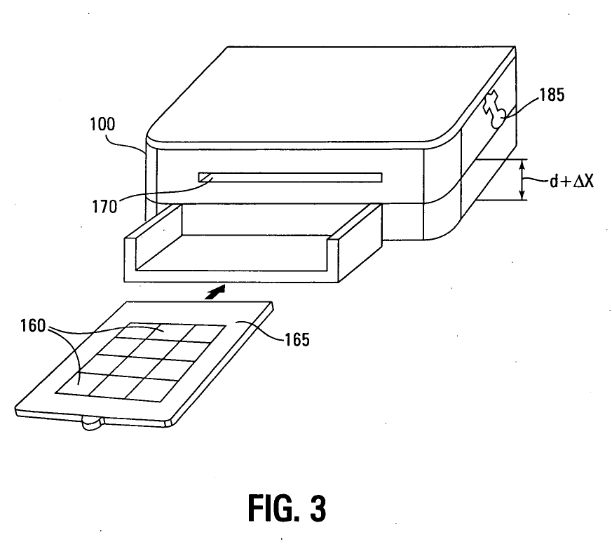

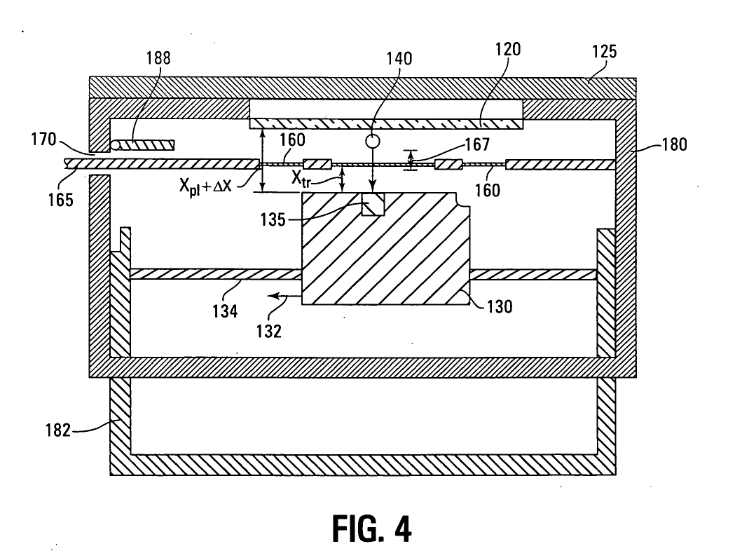

FIGS. 3 and 4 illustrate scanner 100 operating in a transparent scanning mode for scanning at least partially transparent media, or media substantially transparent to visible light (hereinafter referred to as transparent media), such as transparencies, photo-negatives, slides, etc., according to another embodiment, where FIG. 3 is a perspective view and FIG. 4 is a cross-sectional side view. For another embodiment, the transparent media, such as transparent media 160, may be disposed in a template 165 that may be received through an opening 170 of scanner 100 for scanning in the transparent scanning mode, as shown in FIGS. 3 and 4.

In the transparent scanning mode, for one embodiment, light source 140 may be moved away from carriage 130 and toward platen 120. For another embodiment, light source 140 may be aligned with CIS chip 135 so that light source 140 is directly above CIS chip 135, as shown in FIG. 4. The transparent media or template 165 containing transparent media 160 is inserted into scanner 100 through opening 170 so that the transparent media or template 165 containing transparent media 160 is located between light source 140 and carriage 130. Note that in the transparent scanning mode, the transparent media or template 165 containing transparent media 160 underlies light source 140, which underlies platen 120, so that light source 140 is interposed between the transparent media or template 165 containing transparent media 160 and platen 120, as shown in FIG. 4.

In operation, during the transparent scanning mode, light 150 from light source 140 is directed directly through the transparent media and onto CIS chip 135, as shown in FIG. 4. CIS chip 135 converts the light into one or more electronic signals that correspond to one or more images on the transparent media. For one embodiment, the electronic signals may sent to computer 115 (FIG. 1) for processing, or may be processed by firmware of scanner 100.

For one embodiment, opaque media 110 and the transparent media lie within the depth of field (or region of useful image quality) 167 of CIS chip 135 during the opaque and transparent scanning modes, respectively, as shown in FIGS. 2 and 4, so that opaque media 110 and the transparent media are substantially in focus during the opaque and transparent scanning modes. Note that objects, e.g., one or more images on either opaque media 110 or the transparent media, located within the depth of field 167 of CIS chip 135 are substantially in focus.

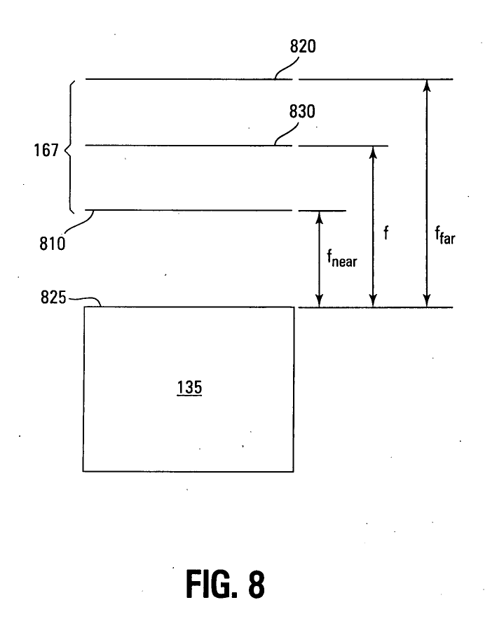

FIG. 8 illustrates the depth of field 167 of CIS chip 135, according to one embodiment. The depth of field 167 lies between a near bounding plane 810 and a far bounding plane 820 respectively located at distances fₙₑₐᵣ and f_{far} from an upper surface 825 CIS chip 135. CIS chip 135 has a focal length f between the distances fₙₑₐᵣ, and f_{far}. A focal plane 830 is located between the near and far planes at the focal length f Note that the focal length is the distance from CIS chip 135 where an object is precisely in focus.

Specifically, for another embodiment, scanner 100 is configured so that in the opaque scanning mode, a distance xₒₚ (FIG. 2) between the downward facing surface of opaque media 110 and the upper surface of CIS chip 135, i.e., the distance between one or more images on opaque media 110 and the upper surface of CIS chip 135, is within the depth of field 167, as shown in FIG. 2. This acts to ensure that the one or more images on the opaque media 110 are substantially in focus during the opaque scanning mode. Scanner 100 is further configured so that in the transparent scanning mode, a distance xₜᵣ (FIG. 4) between the downward facing surface of the transparent media, e.g., transparent media 160, and the upper surface CIS chip 135, i.e., the distance between one or more images on the transparent media and the upper surface of CIS chip 135, is within the depth of field 167, as shown in FIG. 4. This acts to ensure that the one or more images on the transparent media are substantially in focus during the transparent scanning mode.

For another embodiment, scanner 100 is configured so that the distances xₒₚ and xₜᵣ are substantially equal to each other. This enables the one or more images scanned from the opaque media and the one or more images scanned from the transparent media to have substantially the same image quality. For another embodiment, the distances xₒₚ and xₜᵣ are both equal to the focal length f (FIG. 8) of CIS chip 135 so that images on the opaque media and the transparent media lie in the focal plane 830 of CIS chip 135.

Note that for one embodiment, placing opaque media on platen 120, when the scanner is in the opaque scanning mode, positions one or more images on the opaque media within the depth of field 167. For another embodiment, when the one or more images on the opaque media are within the depth of field 167, the one or more images are located in the focal plane of CIS chip 135. For one embodiment, opening 170 is located such that when the transparent media or template 165 containing transparent media 160 is inserted therethrough, one or more images on the transparent media are located within the depth of field 167. For another embodiment, when the one or more images on the transparent media are within the depth of field 167, the one or more images are located in the focal plane of CIS chip 135.

For one embodiment, platen 120 may be located at a distance xₚₗ from carriage 130 in the opaque scanning mode, as shown in FIG. 2, so that when opaque media 110 is on platen 120, at least one image on opaque media 110 is within the depth of field of CIS chip 135. In the transparent scanning mode, platen 120 may be located and at a distance xₚₗ+Δx from carriage 130, as shown in FIG. 4, so that when the transparent media is positioned underlying platen 120, at least one image on the transparent media is within the depth of field of CIS chip 135. For one embodiment, in the transparent scanning mode, the distance xₚₗ+Δx between platen 110 and carriage 130 accommodates light source 140 and the transparent media, as shown in FIG. 4.

For one embodiment, the distance between platen 110 and carriage 130 may be increased from the distance xₚₗ in the opaque scanning mode (FIG. 2) to the distance xₚₗ+Δx in the transparent scanning mode (FIG. 4) by raising an upper portion 180 of scanner 100 relative to a lower portion 182 of scanner 100 or decreased from the distance xₚₗ+Δx to the distance xₚₗ by lowering upper portion 180 relative to lower portion 182, e.g., as lower portion 182 remains stationary. Note that raising or lowering upper portion 180 relative to lower portion 182 respectively moves platen 120 away from or toward carriage 130, as shown in FIGS. 2 and 4. Alternatively, lower portion 182 may be raised or lowered relative to upper portion 180 to respectively move carriage 130 toward or away from platen 120, e.g., as upper portion 180 remains stationary.

For another embodiment, the distance between platen 110 and carriage 130 may be increased before or concurrently with moving light source 140 from its opaque-scanning position in FIG. 2 to its transparent-scanning position in FIG. 4 and may be decreased after or concurrently with moving light source 140 from its transparent-scanning position in FIG. 4 to its opaque-scanning position in FIG. 2. For another embodiment, the distance between platen 110 and carriage 130 may be increased or decreased in response to user inputs to a user interface (not shown) of scanner 100 or to computer 115 (FIG. 1), e.g., upon the user selecting the transparent or opaque scanning mode.

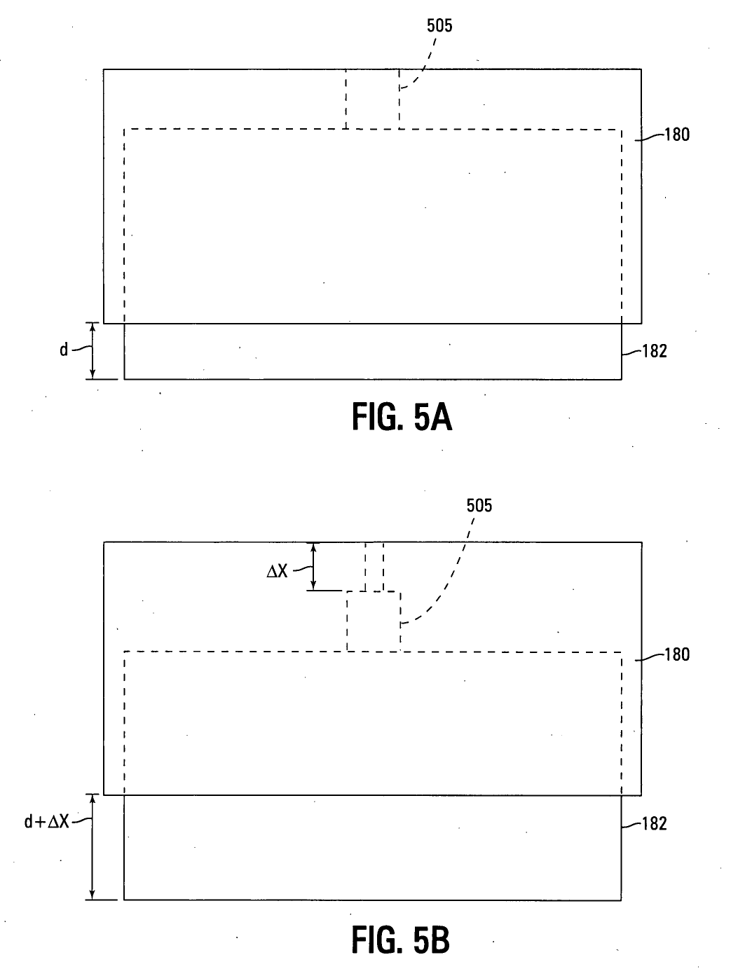

For one embodiment, an actuator, such as a solenoid 505, may be used to selectively raise or lower upper portion 180 relative to lower portion 182, as shown in the side views of FIG. 5A (opaque scanning mode) and FIG. 5B (transparent scanning mode). For one embodiment, solenoid 505 raises or lowers upper portion 180 relative to lower portion 182 in response to receiving electrical signals, e.g., in response to the user inputs. Alternatively, a solenoid (not shown) may be used to selectively raise or lower the lower portion 182 relative to upper portion 180 in response to receiving electrical signals, e.g., in response to the user inputs. Note that raising upper portion 180 relative to lower portion 182 or lowering lower portion 182 relative to upper portion 180 increases a distance d between the bottom of upper portion 180 and the bottom of lower portion 182 to a distance d+Δx, as shown in FIGS. 5A and 5B.

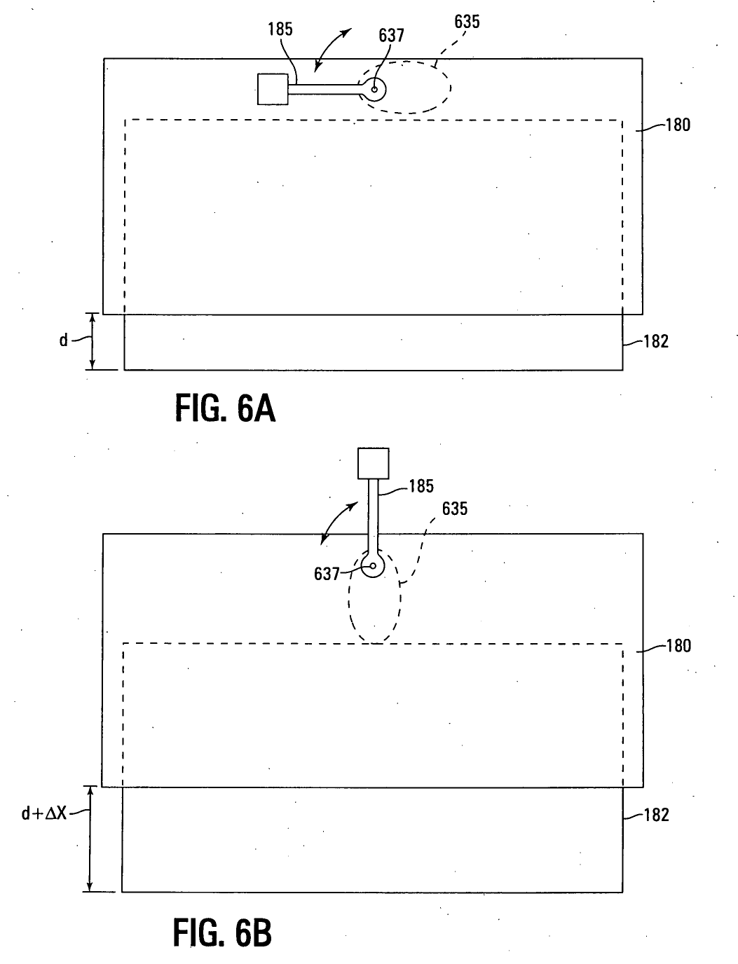

For one embodiment, upper portion 180 of scanner 100 may be raised and lowered manually, relative to lower portion 182 of scanner 100, by the distance Δx using one or more actuators 185, as shown in FIGS. 1 and 3 and in the side views of FIGS. 6A and 6B. Note that raising upper portion 180 relative to lower portion 182 increases the distance between platen 120 and carriage 130 from the distance xₚₗ in the opaque scanning mode (FIG. 2), to the distance xₚₗ+Δx in the transparent scanning mode (FIG. 4). For another embodiment, an actuator 185 may include an eccentric lobe 635, as shown in FIGS. 6A and 6B. The actuator 185 may be rotatably attached to the upper portion 180 by a pin 637 that passes through a bushing or bearing (not shown) fixed to a sidewall of upper portion 180. For another embodiment, an actuator 185 may be rotatably attached to opposing sidewalls of upper portion 180 on either side of platen 110 in the manner of FIGS. 6A and 6B.

Rotating actuator 185 rotates lobe 635 about pin 637, causing lobe 635 to engage an upper surface of bottom portion 182, as shown in FIG. 6B. The engagement between lobe 635 and bottom portion 182 exerts a vertical component of force on pin 637 that in turn exerts a vertical component of force on upper portion 180, via the bushings or bearings, that raises upper portion 180. Rotating actuator 185 in the opposite direction lowers upper portion 180.

For another embodiment, a door 188 may be used to close the opening 170 when scanner 100 is operating in the opaque scanning mode, as shown in FIG. 2. For one embodiment, door 188 extends into a notch formed in a wall of lower portion 182 (FIG. 2) so that door 188 cannot be opened when scanner 100 is operating in the opaque scanning mode. Raising upper portion 180 relative to lower portion 182 or lowering portion 182 relative to upper portion 180 withdraws door 188 from its notch so that door 188 can be opened when scanner 100 is operating in the transparent scanning mode, as shown in FIG. 4. For one embodiment, door 188 may be biased open, e.g., by a torsional spring, so that door 188 opens in response to door 188 being withdrawn from its notch.

FIGS. 7A and 7B are side views of carriage 130 as may be viewed with one of the sidewalls of scanner 100 removed, according to another embodiment. FIG. 7C is a view taken along line 7C-7C of FIG. 7B. For one embodiment, light source 140 includes a light-pipe 710. For another embodiment, light source 140 may include an enclosure 720 that is physically connected to light-pipe 710. For example, a flange 725 that is fixed to light-pipe 710 may be fixed to enclosure 720, e.g., by cap screws, for physically connecting light-pipe 710 to enclosure 720, as shown in FIG. 7C. For one embodiment, light source 140 may be selectively rotatably connected to carriage 130 by a shaft 730 that may be fixedly connected to enclosure 720 and rotatably connected to carriage 130, e.g., by bushings or bearings (not shown) fixed to carriage 130. For another embodiment, shaft 730 may be connected to a motor 735, such as a stepper motor, mounted on carriage 130, as shown in FIG. 7C. During operation, motor 735 selectively rotates light source 140, relative to carriage 130, from its position in the opaque scanning mode of FIG. 7A to its position in the transparent scanning mode of FIGS. 7B and 7C and vice versa.

For one embodiment, motor 735 rotates light source 140 between the positions of FIGS. 7A and 7B in response to electrical signals from a controller (not shown) of scanner 100. For another embodiment, the controller controls motor 735 in response to user inputs to computer 115 (FIG. 1) or to the user interface of scanner 100. For example, the controller may send an electrical signal that causes motor 735 to rotate light source 140 to the position of FIG. 4B in response to the user selecting the transparency mode of operation, e.g., from a menu displayed on the monitor of computer 115 or the user interface of scanner 100.

For another embodiment, light source 140 includes LEDs 740, such as red, blue, and green LEDs, that may be disposed in enclosure 720 for rotation therewith, as shown in FIG. 7C. LEDs 740 are located adjacent an end of light-pipe 710 and are optically coupled to light-pipe 710. During a scan, LEDs 740 flash on and off to respectively expose the opaque or transparent media. For example, the red LED lights for a red exposure etc. Light-pipe 710 captures the light from an illuminated LED and distributes the light over a scan line that spans the opaque or transparent media in a direction perpendicular to the motion carriage 130, as shown in FIG. 7C. Note that for one embodiment, light pipe 710 spans at least the width of platen 120 in a direction perpendicular to the direction of motion of carriage 130 during scanning. For one embodiment, light pipe 710 spans the width of CIS chip 135 in a direction perpendicular to the direction of motion of carriage 130 during scanning.

### CONCLUSION

Although specific embodiments have been illustrated and described herein it is manifestly intended that the scope of the claimed subject matter be limited only by the following claims and equivalents thereof.

What is claimed is:

1. A scanner, comprising:
a movable carriage;
a contact image sensor located on the carriage for movement therewith; and
a platen that is substantially transparent to visible light overlying the carriage and the contact image sensor;
wherein the scanner is selectively configurable between a first scanning mode for scanning substantially opaque media positioned on the platen and a second scanning mode for scanning media substantially transparent to visible light underlying the platen;
wherein when the scanner is in the first scanning mode, at least one image on the substantially opaque media is located within a depth of field of the contact image sensor when the substantially opaque media is positioned on the platen; and
wherein when the scanner is in the second scanning mode, at least one image on the media substantially transparent to visible light is located within the depth of field of the contact image sensor when the media substantially transparent to visible light underlies the platen.

2. The scanner of claim 1, wherein when the at least one image on the substantially opaque media and the at least one image on the media substantially transparent to visible light are respectively located within the depth of field of the contact image sensor during the respective first and second scanning modes, the at least one image on the substantially opaque media and the at least one image on the media substantially transparent to visible light are respectively located at substantially the same distance from the contact image sensor.

3. The scanner of claim 2, wherein when the at least one image on the substantially opaque media and the at least one image on the media substantially transparent to visible light are respectively located at substantially the same distance from the contact image sensor, the distance from the contact image sensor is substantially equal to a focal length of the contact image sensor.

4. The scanner of claim 1, wherein when the at least one image on the substantially opaque media is located within a depth of field of the contact image sensor when the substantially opaque media is positioned on the platen, the at least one image on the substantially opaque media lies in a focal plane of the contact image sensor.

5. The scanner of claim 1, wherein when the at least one image on the media substantially transparent to visible light is located within the depth of field of the contact image sensor when the media substantially transparent to visible light underlies the platen, the at least one image on the media substantially transparent to visible light lies in a focal plane of the contact image sensor.

6. The scanner of claim 1, wherein a distance between the platen and the contact image sensor is selectively adjustable between a first position so that when the substantially opaque media is on the platen, the at least one image on the substantially opaque media is within the depth of field of the contact image sensor and a second position so that when the media substantially transparent to visible light is positioned underlying the platen, the at least one image on the media substantially transparent to visible light is within a depth of field of the contact image sensor.

7. The scanner of claim 1, wherein the platen is selectively movable between a first position so that when the substantially opaque media is on the platen, the at least one image on the substantially opaque media is within the depth of field of the contact image sensor and a second position so that when the media substantially transparent to visible light is positioned underlying the platen, at least one image on the media substantially transparent to visible light is within a depth of field of the contact image sensor.

8. The scanner of claim 1 further comprises a light source physically connected to the carriage for moving therewith.

9. The scanner of claim 8, wherein the light source comprises a light-pipe optically coupled to one or more light emitting diodes.

10. The scanner of claim 8, wherein the light source is selectively movable, relative to the carriage, between a first position for scanning the substantially opaque media in the first scanning mode and a second position for scanning media substantially transparent to visible light in the second scanning mode.

11. The scanner of claim 10, wherein the platen is interposed between the substantially opaque media and the light source during the first scanning mode, and wherein the light source is interposed between the platen and the media substantially transparent to light during the second scanning mode.

12. The scanner of claim 1 further comprises an opening through which the media substantially transparent to light is inserted into the scanner for scanning.

13. The scanner of claim 12, wherein the opening is located such that when the transparent media is inserted therethrough, one or more images on the transparent media are located within the region of useful image quality.

14. The scanner of claim 12, wherein the opening is located such that when the transparent media is inserted therethrough, one or more images on the transparent media are located in the focal plane of the contact image sensor.

15. The scanner of claim 12 further comprises a door that closes the opening.

16. The scanner of claim 15, wherein the door can be opened during the second scanning mode, but cannot be opened during the first scanning mode.

17. The scanner of claim 1, wherein the media substantially transparent to light is disposed in a template.

18. The scanner of claim 1, wherein the scanner is an integral component of an all-in-one device.

19. A scanner, comprising:
a movable carriage;
a contact image sensor located on the carriage for movement therewith;
a platen that is substantially transparent to visible light overlying the carriage and the contact image sensor; and
a light source physically connected to the carriage for moving therewith, the light source selectively movable between a first position for scanning substantially opaque media positioned on the platen, and overlying the light source, and a second position for scanning media substantially transparent to visible light underlying the light source;
wherein a distance between the platen and the contact image sensor is selectively adjustable between a first position so that when the substantially opaque media is on the platen, at least one image on the substantially opaque media is within a depth of field of the contact image sensor and a second position so that when the media substantially transparent to visible light is positioned underlying the platen, at least one image on the media substantially transparent to visible light is within the depth of field of the contact image sensor.

20. The scanner of claim 19, wherein when the at least one image on the substantially opaque media and the at least one image on the media substantially transparent to visible light are respectively located within the depth of field of the contact image sensor, the at least one image on the substantially opaque media and the at least one image on the media substantially transparent to visible light are respectively located at substantially the same distance from the contact image sensor.

21. The scanner of claim 20, wherein when the at least one image on the substantially opaque media and the at least one image on the media substantially transparent to visible light are respectively located at substantially the same distance from the contact image sensor, the distance from the contact image sensor is substantially equal to a focal length of the contact image sensor.

22. The scanner of claim 19, wherein when the at least one image on the substantially opaque media is located within a depth of field of the contact image sensor when the substantially opaque media is positioned on the platen, the at least one image on the substantially opaque media lies in a focal plane of the contact image sensor.

23. The scanner of claim 19, wherein when the at least one image on the media substantially transparent to visible light is located within the depth of field of the contact image sensor when the media substantially transparent to visible light underlies the platen and the light source, the at least one image on the media substantially transparent to visible light lies in a focal plane of the contact image sensor.

24. A method of operating a scanner, comprising:
scanning substantially opaque media disposed on a platen of the scanner that is substantially transparent to visible light using visible light, wherein scanning the substantially opaque media comprises:
directing visible light through the platen and onto the substantially opaque media; and
directing the visible light from the substantially opaque media back through the platen and onto a contact image sensor of the scanner disposed on a moving carriage of the scanner;
wherein when the substantially opaque media is disposed on the platen, at least one image on the substantially opaque media is located within a depth of field of the contact image sensor; and
scanning media substantially transparent to visible light underlying the platen using visible light, wherein scanning the media substantially transparent to visible light comprises:
directing the visible light through the media substantially transparent to visible light and onto the contact image sensor;
wherein when the media substantially transparent to visible light underlies the platen, at least one image on the media substantially transparent to visible light is located within the depth of field of the contact image sensor.

25. The method of claim 24, wherein the visible light used to scan the substantially opaque media and the visible light used to scan the media substantially transparent to visible light is supplied from a light source of the scanner connected to the moving carriage of the scanner.

26. The method of claim 25 further comprises before scanning the media substantially transparent to visible light, moving the light source relative to the carriage from a first position for scanning the substantially opaque media to a second position for scanning the media substantially transparent to visible light.

27. The method of claim 24, wherein scanning the media substantially transparent to visible light further comprises converting the light directed onto the contact image sensor into an electronic signal that corresponds to the at least one image on the media substantially transparent to visible light using the contact image sensor.

28. The method of claim 24, wherein scanning the substantially opaque media further comprises converting the light directed onto the contact image sensor into an electronic signal that corresponds to the at least one image on the substantially opaque media using the contact image sensor.

29. The method of claim 24, wherein directing the visible light from the substantially opaque media back through the platen and onto a contact image sensor comprises reflecting the visible light from the substantially opaque media back through the platen and onto a contact image sensor.

30. The method of claim 24 further comprises before scanning the media substantially transparent to visible light, increasing a distance between the platen and a carriage of the scanner.

31. The method of claim 30, wherein increasing a distance between the platen and the carriage comprises raising an upper portion of the scanner that contains the platen.

32. The method of claim 24, wherein when the at least one image on the substantially opaque media and the at least one image on the media substantially transparent to visible light are respectively located within the depth of field of the contact image sensor, the at least one image on the substantially opaque media and the at least one image on the media substantially transparent to visible light are respectively located at substantially the same distance from the contact image sensor.

33. The method of claim 32, wherein when the at least one image on the substantially opaque media and the at least one image on the media substantially transparent to visible light are respectively located at substantially the same distance from the contact image sensor, the distance from the contact image sensor is substantially equal to a focal length of the contact image sensor.
